(19) United States
(12) Patent Application Publication
(10) Pub. No.: US 2003/0003431 A1
(43) Pub. Date: Jan. 2, 2003

(54) Music delivery system

(75) Inventor: Shigenobu Maeda, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 10/125,471

(22) Filed: Apr. 19, 2002

(30) Foreign Application Priority Data
May 24, 2001 (JP) 2001-155372

(51) Int. Cl. G09B 23/28

(52) U.S. Cl. 434/307 A

(57) ABSTRACT

It is an object to provide a music delivery system capable of delivering a music with which each listener can easily gain sympathy. There are provided a delivery server (1) for storing musical accompaniment data and lyrics data (voice data, that is, text data for a karaoke delivery system) of a plurality of tunes and for delivering the same data on request, and a receiving terminal (2) for giving a request for delivering data to the delivery server (1) and receiving the delivery upon receipt of an instruction from a user. In such a music delivery system, for example, a part of the lyrics data are constituted by a change data block which can be changed and are changed depending on a position of presence of the receiving terminal. For example, a tune of “Woman in Nagoya” is transmitted to a receiving terminal in Nagoya and the “Nagoya” in a title of the “Woman in Nagoya” and lyrics is changed into “Hakata” to be delivered to a receiving terminal in Hakata. The change is carried out according to the position of presence of the receiving terminal (2) and information about an attribute such as a birth place of a user or a taste thereof.

### BACKGROUND OF THE INVENTION

1. Field of the Invention

The present invention relates to a music delivery system for delivering music data, karaoke data and the like.

2. Description of the Background Art

For example, Japanese Patent Application Laid-Open No. 9-114473 (1997) and Japanese Patent Application Laid-Open No. 2000-36795 have described a system in which a delivery server stores music data, karaoke data (accompaniment music data and lyrics data) and the like and data to be desired are delivered when a request is given from a terminal.

In some cases in which a singer sings a theme with lyrics to accompaniment, a sale of the tune is influenced depending on the contents of the lyrics.

FIG. 1 shows an example of lyrics. In lyrics LY1, “Nagoya” is a name of one of cities in Japan and “Hisaya Main Street” and “Sakae” are names of a famous park and a downtown in the “Nagoya”.

For example, the lyrics LY1 have names of specific places such as A. “Nagoya”, B. “Hisaya Main Street” and C. “Sakae”. In the case of the lyrics having the names of the places, a tune having the lyrics might be well received by listeners who live in the same places. However, it is supposed that the tune is not well received by listeners who live in other places because the included names of places are unfamiliar to them.

As described above, the sale of a music having the lyrics is varied depending on how much listeners gain sympathy with the contents of the lyrics.

### SUMMARY OF THE INVENTION

It is an object of the present invention to provide a music delivery system capable of delivering a music with which each listener can easily gain sympathy.

An aspect of the present invention is directed to a music delivery system. The music delivery system includes a delivery server for storing at least one of musical accompaniment data and lyrics data of a plurality of tunes including at least one of a musical accompaniment and lyrics and for delivering the data on request, and a receiving terminal for giving a request for delivering at least one of the musical accompaniment data and the lyrics data to the delivery server and receiving the delivery upon receipt of an instruction from a user. A part of or all of at least one of the musical accompaniment data and the lyrics data are constituted by a change data block which can be changed and at least one of the musical accompaniment data and the lyrics data can be thereby changed at the delivery server or the receiving terminal.

According to the present invention, a part or all of at least one of the musical accompaniment data and the lyrics data are constituted by the change data block which can be changed and at least one of the musical accompaniment data and the lyrics data can be thereby changed at the delivery server or the receiving terminal. For example, accordingly, the portion of the name of the place in the lyrics data can be constituted by the change data block to change and deliver the lyrics data according to a birth place of each user or the like. Thus, it is possible to implement a music delivery system capable of providing a music with which each listener can easily gain sympathy. Moreover, in the case in which one tune has a plurality of variations, it is sufficient that data on a changed portion are stored as a selection choice of the change data block in addition to a common portion between the variations. Therefore, it is possible to reduce a storage volume in the delivery server as compared with the case in which the tune is stored as an individual tune.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are diagrams showing an example of lyrics,

FIG. 3 is a diagram showing a change table for a change data block in a music delivery system according to a first embodiment,

FIG. 4 is a diagram showing the music delivery system according to the first embodiment,

FIG. 5 is a diagram showing a music delivery system according to the first to ninth embodiments,

FIG. 6 is a diagram showing related information in the music delivery system according to the second embodiment,

FIG. 7 is a diagram showing a questionnaire to be answered by a user,

FIG. 8 is a diagram showing the music delivery system according to the third embodiment,

FIG. 9 is a diagram showing the music delivery system according to the fourth embodiment,

FIG. 10 is a diagram showing the music delivery system according to the fifth embodiment,

FIG. 11 is a diagram showing a flow in the music delivery system according to the sixth embodiment,

FIG. 12 is a diagram showing the music delivery system according to the eighth embodiment,

FIGS. 13 and 14 are diagrams showing a flow in the music delivery system according to the eighth embodiment,

FIG. 15 is a diagram showing an example of structures of musical accompaniment data and lyrics data in the music delivery system according to the ninth embodiment, and

FIG. 16 is a diagram showing the music delivery system according to the ninth embodiment.

### DESCRIPTION OF THE PREFERRED EMBODIMENTS

### First Embodiment

The present embodiment implements a music delivery system capable of changing musical accompaniment data and lyrics data (data on a voice singing lyrics and text data on the lyrics notated in characters) depending on a position of presence of a receiving terminal when delivering the musical accompaniment data and the lyrics data from a delivery server to the receiving terminal. Consequently, it is possible to provide a music delivery system capable of delivering a music with which each listener can easily gain sympathy. In the present application, the “musical accompaniment” indicates an instrumental music played by only an instrument and the “lyrics” indicate a language series to be sung in the musical accompaniment.

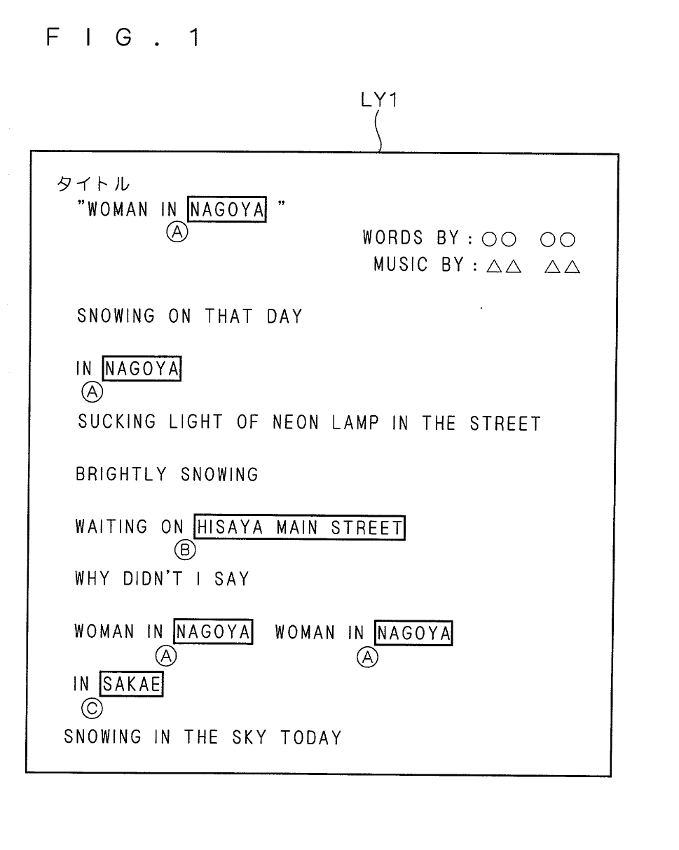

The music delivery system according to the present embodiment will be described by taking the lyrics LY1 shown in FIG. 1 as an example. In the case of the lyrics LY1, as described above, names of specific places such as A. “Nagoya”, B. “Hisaya Main Street” and C. “Sakae” appear and the lyrics LY1 are well received by only listeners who live in the same places. In the present embodiment, accordingly, such a place name portion in the lyrics is changed into data as a change data block which can be changed and is varied depending on a position of presence of a receiving terminal for a delivery destination.

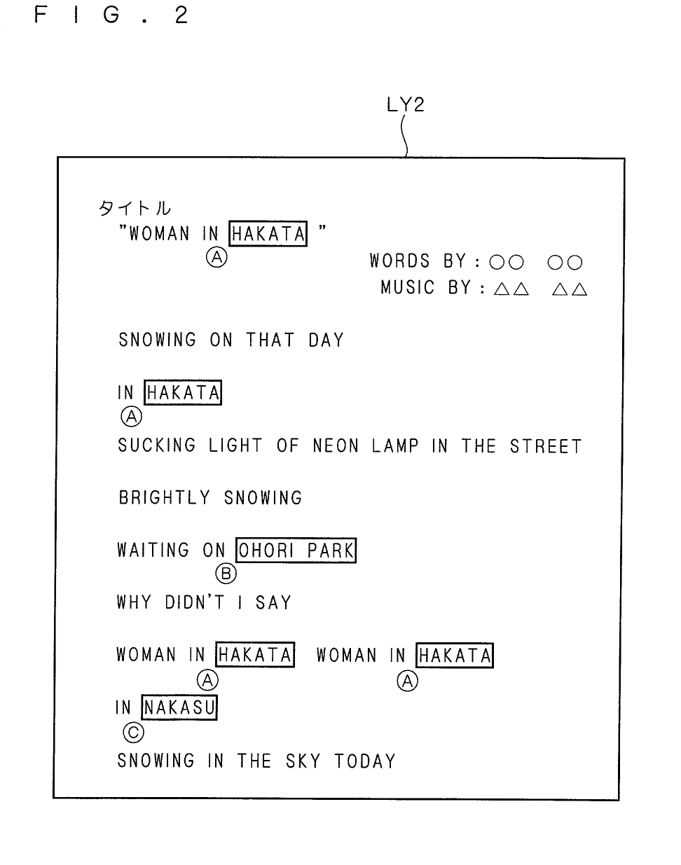

More specifically, as shown in lyrics LY2 of FIG. 2, a title of a tune and the place name portions A to C in the lyrics are changed. In the lyrics LY2, for example, A. “Nagoya”, B. “Hisaya Main Street” and C. “Sakae” are changed into “Hakata”, “Ohori Park” and “Nakasu”, respectively. In the lyrics LY2, the “Hakata” is a name of one of cities in Japan, and the “Ohori Park” and the “Nakasu” are names of a famous park and a downtown in the “Hakata”.

In the lyrics LY1 and LY2, the portions A to C are constituted as change data blocks and other portions are constituted as common lyrics data. More specifically, the voice data and text data on the lyrics data are prepared for each of the portions A to C together, and proper lyrics data are incorporated into lyrics data in other common portions and are thus delivered depending on the position of presence of the receiving terminal.

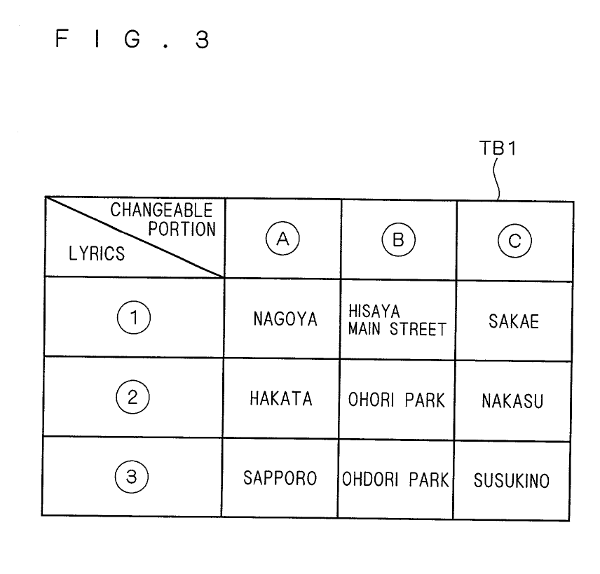

It is preferable that such a change data block should be changed into data as a change table TB1 as shown in FIG. 3. “Sapporo” in lyrics \mathring{3} of the change table TB1 is also the name of one of cities in Japan, and the “Ohdori Park” and “Susukino” are also the names of a famous park and a downtown in the “Sapporo”.

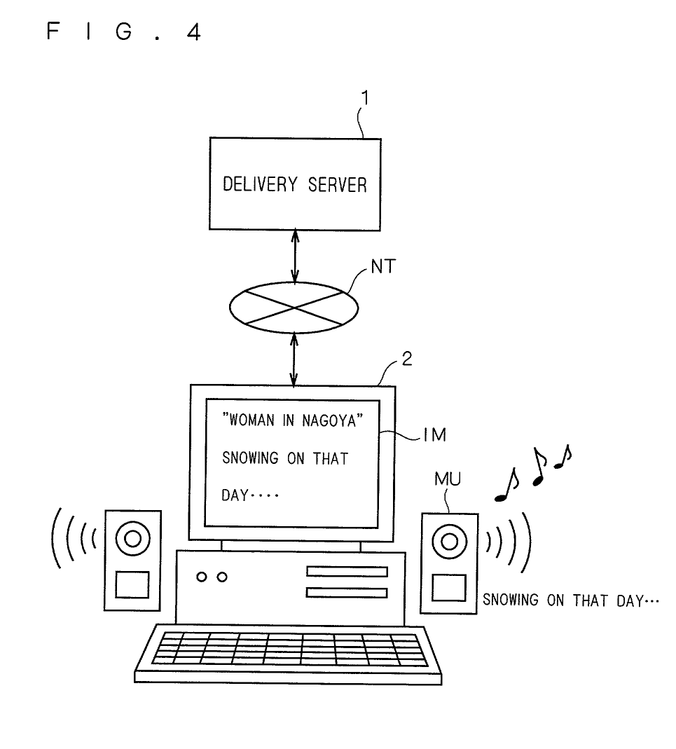

The structure of the music delivery system capable of changing the lyrics data will be described below. FIG. 4 shows the structure of the music delivery system according to the present embodiment. In FIG. 4, the reference numeral 1 denotes a delivery server for storing musical accompaniment data and lyrics data in a plurality of tunes having a musical accompaniment and lyrics and for delivering them through a network NT on request, and the reference numeral 2 denotes a receiving terminal for giving a request to delivery the musical accompaniment data and the lyrics data to the delivery server 1 and receiving the delivery upon receipt of an instruction from a user. The receiving terminal 2 in the present embodiment supposes an information terminal such as a personal computer to be used by a user in home, for example.

The receiving terminal 2 includes a video display section IM such as a display monitor and a music output section MU such as a speaker, and the delivered musical accompaniment data and the voice data in the lyrics data are output as a music from the music output section MU. Moreover, the text data in the lyrics data are output to the video display section IM.

It is sufficient that the musical accompaniment data are MIDI (Musical Instrument Digital Interface) data in conformity with the MIDI standard, musical performance data recorded digitally, compression data obtained by compressing the digital musical performance data based on the MP3 (MPEG 1 Audio Layer III) standard, and the like. Moreover, it is sufficient that the voice data in the lyrics data are singing data in which a singing voice of a singer is digitally recorded, compression data of the singing data or the like and the text data in the lyrics data are character data in a text file format.

If the lyrics data include the voice data, the voice of the singer can be reproduced at the receiving terminal 2. Moreover, if the lyrics data include the text data, they can be utilized for displaying lyrics telop at the receiving terminal.

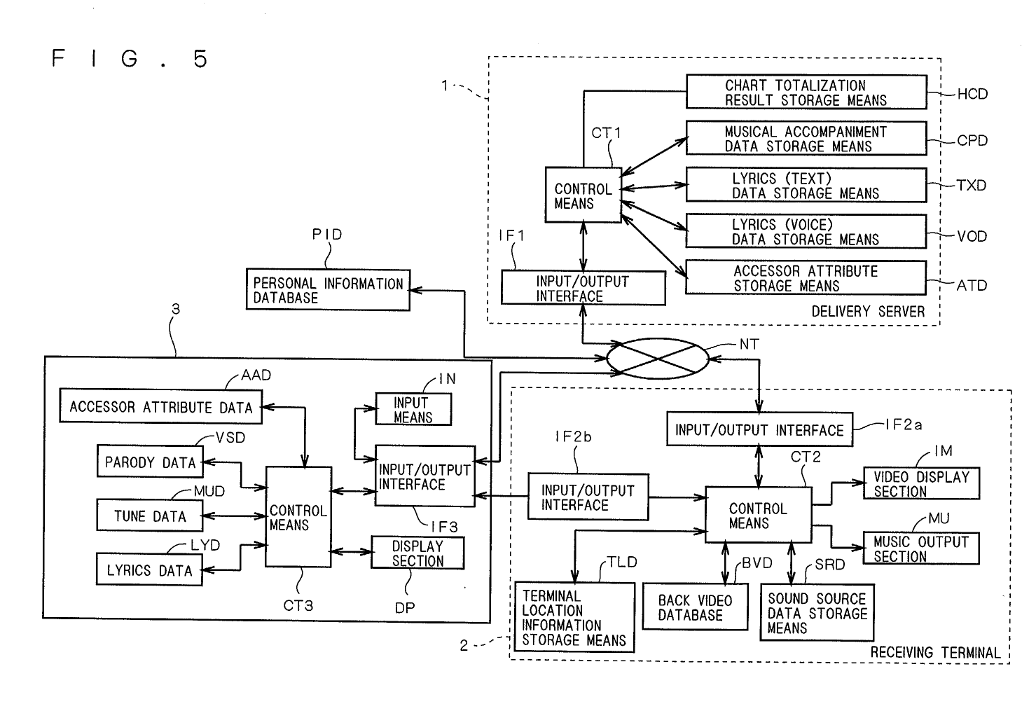

FIG. 5 is a diagram showing the structure of the music delivery system in FIG. 4 more specifically. In FIG. 5, components which are not indicated in the present embodiment are also described in order to illustrate a structure in each of embodiments subsequent to the present embodiment.

Accordingly, the components which will be indicated in the following description are indispensable to the music delivery system shown in FIG. 4, and components which are shown in FIG. 5 but are not described in the present embodiment are not necessary for the present embodiment. This can also be applied to the description of other embodiments.

As shown in FIG. 5, a delivery server 1 comprises control means CT1 for controlling exchange of data, an input/output interface IF1 to be an interface for information circulation between the control means CT1 and an external network (internet or the like) NT, musical accompaniment data storage means CPD for storing musical accompaniment data, lyrics (text) data storage means TXD for storing text data in lyrics data, lyrics (voice) data storage means VOD for storing voice data in the lyrics data and accessor attribute storage means ATD for storing an attribute of an accessor (on the assumption that the position of presence of the receiving terminal is the attribute of the accessor).

The control means CT1 is a general CPU (Central Processing Unit) having a ROM (Read Only Memory), a RAM (Random Access Memory) and the like connected thereto and is a functional component to be operated by a predetermined software program. Moreover, the input/output interface IFI indicates software and hardware for an external communicating interface which include a communicating device such as a modem or a terminal adapter. Furthermore, each of the musical accompaniment data storage means CPD, the lyrics (text) data storage means TXD, the lyrics (voice) data storage means VOD and the accessor attribute storage means ATD is a storage device having a large scale capacity such as a hard disk.

Moreover, the receiving terminal 2 comprises control means CT2 for controlling exchange of data, an input/output interface IF2a to be an interface for information circulation between the control means CT2 and the external network NT, sound source data storage means SRD to be provided if sound source data are required for reproducing the musical accompaniment data, (for example, the musical accompaniment data are MIDI data and sampling data on a sound source waveform are required for the receiving terminal), terminal location information storage means TILD for storing information about a location of the receiving terminal 2, a video display section for displaying a video, and a music output section MU for outputting the delivered data as a music.

The control means CT2 is also a general CPU having a ROM, a RAM and the like connected thereto and is a finctional component to be operated by a predetermined software program. Moreover, the input/output interface IF2a also indicates software and hardware of an external communicating interface which also include a communicating device such as a modem or a terminal adapter. Furthermore, each of the sound source data storage means SRD and the terminal location information storage means TLD is a nonvolatile storage device such as a flash memory.

In the music delivery system having such a structure, description will be given to a state in which a place name portion in lyrics is changed into data as a change data block and is varied depending on a position of presence of a receiving terminal for a delivery destination.

First of all, when the receiving terminal 2 is to give a request for delivering a music to the delivery server 1 upon receipt of an instruction from a user, the control means CT2 sends, to the delivery server 1, terminal location information stored in the terminal location information storage means TLD together with information about the user's request.

The delivery server 1 receiving the information about the user's request retrieves data on a corresponding request tune from the musical accompaniment data storage means CPD, the lyrics (text) data storage means TXD and the lyrics (voice) data storage means VOD. Moreover, the terminal location information is stored as user attribute information in the accessor attribute storage means ATD.

As shown in. FIGS. 1 and 2, for example, in the case in which a part or all of lyrics data of the request tune are constituted by a change data block which can be changed, voice data and text data in each of A to C portions to be the change data blocks are stored in the lyrics (text) data storage means TXD and the lyrics (voice) data storage means VOD respectively, and fuirthermore, voice data and text data in other common portions are also stored respectively.

Each data of the change data block are stored in relation to the terminal location information in each of the storage means. For example, in the case of the change table TB1 in FIG. 3, the change portion A is the change data block and is also information related to the terminal location information.

The control means CT1 searches the information related to the lyrics data which correspond to the terminal location information obtained from the receiving terminal 2 and the corresponding change data block is incorporated into the lyrics data in other common portions to be delivered to the receiving terminal together with the musical accompaniment data. For example, in the case in which the terminal location information is “Nagoya”, “Nagoya”, “Hisaya Main Street” and “Sakae” are incorporated in each of the portions A to C of the lyrics data respectively and are then delivered.

Thus, if one tune has a plurality of variations and data on a change portion are to be stored as a selection choice of the change data block in addition to common portions between the variations, the storage volume of the lyrics data in the delivery server can be reduced as compared with the case in which each variation is stored as an individual tune.

In the receiving terminal 2, the control means CT2 outputs the delivered musical accompaniment data and lyrics data (voice data and text data) to the music output section MU and the video display section IM respectively by utilizing sound source data in the sound source data storage means SRD if necessary.

As described above, the change data block is changed depending on the position of presence of the receiving terminal for the delivery destination. A tune to be stored in the delivery server 1 may include a so—called instrumental tune having no lyrics data but only musical accompaniment data. In that case, the lyrics data cannot be set to the change data block. For example, therefore, it is preferable that a portion or plural portions constituting the musical accompaniment data should be instead changed into data as a change data block which can be changed and the same portion should be varied depending on the position of presence of the receiving terminal for the delivery destination.

As a specific example in which the musical accompaniment data are to be changed, in the case in which the musical accompaniment data are constituted by the MIDI data, it is preferable that a certain track should be set to the change data block and a track to be delivered should be varied depending on the position of presence of the receiving terminal. In the MIDI standard, musical performance data for 16 channels at a maximum can be recorded and a track of the musical performance data can be assigned to an optional channel.

For example, in the case in which the musical accompaniment data are to be delivered to Okinawa (the name of one of cities in Japan), a track of musical performance data having a tone set to a “jabisen (snake-skin samisen : a plucked instrument peculiar to Okinawa)” is delivered. In the case in which the musical accompaniment data are to be delivered to other places in Japan, the same track is delivered with musical performance data having a tone set to a “samisen (a plucked instrument often used in places other than Okinawa in Japan).”

According to the music delivery system in accordance with the present embodiment, a part or all of at least one of the musical accompaniment data and the lyrics data are constituted by the change data block which can be changed. Consequently, it is. possible to change at least one of the musical accompaniment data and the lyrics data in the delivery server 1. Moreover, the lyrics data can be changed and delivered depending on the position of presence of the receiving terminal to be operated by each user. Accordingly, the place name portion in the lyrics data can be constituted by the change data block, thereby changing and delivering the lyrics data depending on the position of presence of the receiving terminal. Thus, it is possible to implement a music delivery system capable of providing a music with which each listener can easily gain sympathy. Moreover, in the case in which one tune has a plurality of variations, the data for a change portion are stored as the selection choice of the change data block in addition to the common portions between the variations. Therefore, it is possible to reduce the storage volume in the delivery server as compared with the case in which the tune is stored as an individual tune.

### Second Embodiment

The present embodiment is a variant of the music delivery system according to the first embodiment. Lyrics include a portion related to an attribute or taste of a user. In the case in which the portion related to the attribute or taste is a change data block, a delivery server 1 changes a selection choice of the change data block of lyrics data based on user information about the attribute or taste of the user.

In the first embodiment, the change data block is stored in relation to terminal location information. In the present embodiment, however, each selection choice of the change data block is related to a keyword in user information related to the attribute or taste of the user and the change data block is changed based on the user information which is previously obtained.

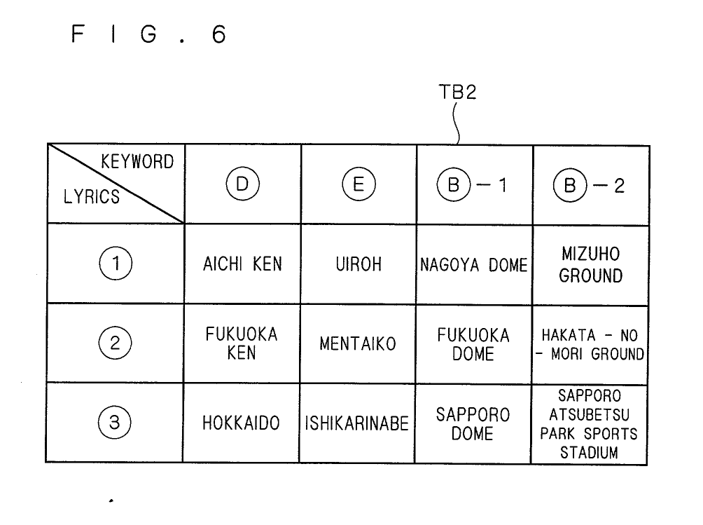

FIG. 6 shows an example of related information for causing the user information to correspond to the change data block. In related information TB2, for example, information about a birth place of a user is employed for a keyword D and information about a favorite food of the user is employed for a keyword E. In the related information TB2, “Aichi Ken” indicates a name of a prefecture where “Nagoya” is present, “Fukuoka Ken” indicates the name of a prefecture where “Hakata” is present, and “Hokkaido” indicates the name of a prefecture where “Sapporo” is present. In the related information TB2, moreover, “Uiroh” indicates a name of a special food in the “Aichi Ken”, “Mentaiko” indicates the name of the special food in the “Fukuoka Ken” and “Ishikarinabe” indicates the name of the special food in the “Hokkaido”.

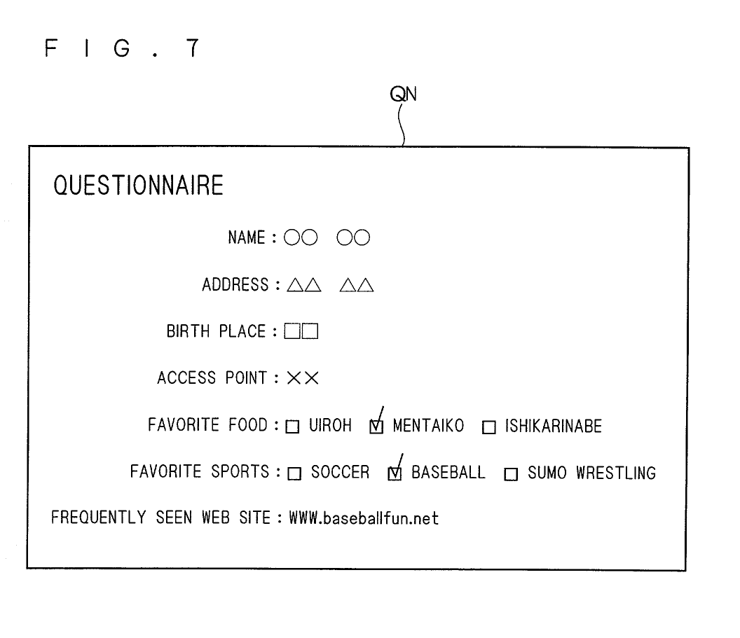

FIG. 7 shows an example of user information to be input to the delivery server 1 through a receiving terminal 2. As an example of the user information, a questionnaire QN answered about the attribute or taste of the user is employed. In the questionnaire QN, “name”, “address”, “birth place”, “access point”, “favorite food”, “favorite sports” and “frequently seen Web site” are examples of a keyword indicative of the attribute and taste of the user, respectively. The “access point” indicates an access point to be used for connecting the receiving terminal 2 to a network NT such as internet and the “frequently seen Web site” indicates URL (Uniform Resource Locater) which the user often visits.

For example, when the user utilizes the music delivery system according to the present embodiment, a manager of the delivery server 1 previously gives the user a request for answering the questionnaire QN. The questionnaire QN answered by the user is given to the delivery server 1 through the receiving terminal 2 and the network NT. The delivery server 1 stores the transmitted questionnaire QN in accessor attribute storage means ATD such that the delivery server 1 can refer thereto when the user accesses to the server 1.

When a request for delivering a music is given from the user, information about a birth place of the user is extracted as a keyword from the questionnaire QN, for example, and the information about the birth place is compared with the keyword D in the related information TB2 of FIG. 6 to retrieve a coincidence. For example, if the birth place of the user is the “Aichi Ken”, \mathring{1} is selected as lyrics data, that is, a selection choice of a change data block in the \mathring{1} in the change table TB1 of FIG. 3 is selected to deliver the lyrics data in FIG. 1 together with musical accompaniment data.

As a matter of course, a plurality of items in the questionnaire QN may be extracted and compared with a plurality of keywords in the related information TB2 to select a change data block having the largest number of coincidences.

According to the music delivery system in accordance with the present embodiment, thus, the delivery server 1 changes a change data block in the lyrics data based on the user information. Accordingly, it is possible to implement a music delivery system capable of changing and delivering the lyrics data depending on the attribute or taste of each user and of providing a music with which each listener can easily gain sympathy.

According to the music delivery system in accordance with the present embodiment, moreover, the keyword is related to the selection choice of the change data block and the selection choice of the change data block is selected based on the selected keyword. Accordingly, each user can easily give the user information to the delivery server 1 and the delivery server 1 can readily select the selection choice of the change data block from the selected keyword.

### Third Embodiment

The present embodiment is also a variant of the music delivery system according to the first embodiment. In the present embodiment, a receiving terminal 2 is not utilized as a domestic information terminal but a karaoke information terminal to be installed in a store for a person doing a karaoke business (a service business for providing only a musical accompaniment for a tune originally having lyrics to cause a user to sing). More specifically, the first embodiment is applied to a communication karaoke delivery system for delivering karaoke data on a new tune through a communication line to each receiving terminal installed in a store of a karaoke manager (which is generally referred to as a “karaoke box”).

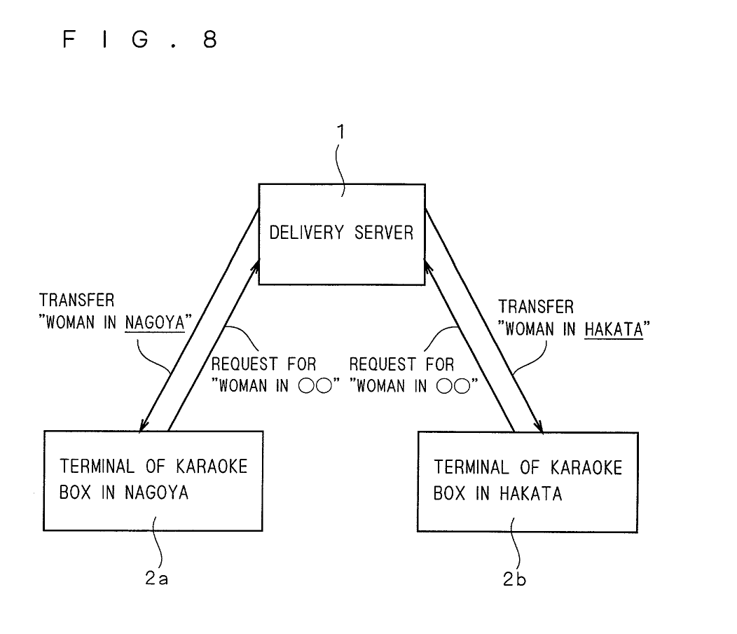

A method of delivering a music when utilizing the receiving terminal 2 as the karaoke information terminal to be installed in a store is basically the same as that in the first embodiment and is different in that the receiving terminal 2 does not require a delivery of voice data as lyrics data. Also in this case, therefore, when “Woman in ◯◯” (which is a tune shown in FIGS. 1 and 2 and has the contents of a change data block in “◯◯”) is requested at a receiving terminal 2a of the karaoke box in “Nagoya”, the “Woman in Nagoya” in FIG. 1 is delivered from the delivery server 1 to the receiving terminal 2a as shown in FIG. 8. Similarly, in the case in which the “Woman in ◯◯” is requested at a receiving terminal 2b of the karaoke box in “Hakata”, “Woman in Hakata” in FIG. 2 is delivered from the delivery service 1 to the receiving terminal 2b.

In each of the receiving terminals 2a and 2b, a portion of “◯◯” may be shown in a blank for a karaoke user, or, “Nagoya”, “Fukuoka” and the like may be notated in advance.

The user information may include an access record obtained when the user accessed the receiving terminal 2 in the past.

For example, in the case in which the user utilizes the karaoke box in each of the “Nagoya” and the “Hakata” and the number of uses in the “Nagoya” is larger than that in the “Hakata”, the delivery server 1 stores the record for a past access place in accessor attribute storage means ATD to select a change data.block selection choice in a place where the number of accesses is large. Also in the case in which the user utilizes the karaoke box in the “Hakata”, consequently, the “Woman in Nagoya” can also be delivered.

Thus, it is possible to implement a music delivery system capable of changing a change data block according to a place where the user accesses the receiving terminal 2 so many times and of providing a music with which each listener can easily gain sympathy.

### Fourth Embodiment

The present embodiment is a variant of the music delivery system according to the third embodiment. While a change data block is changed depending on the position of presence of a receiving terminal in the third embodiment, the change data block is changed by reflecting an attribute or taste of a karaoke user. More specifically, the karaoke user can give user information to a delivery server 1 by utilizing a personal information terminal such as his (her) own mobile telephone or PDA (Personal Digital Assistance), for example.

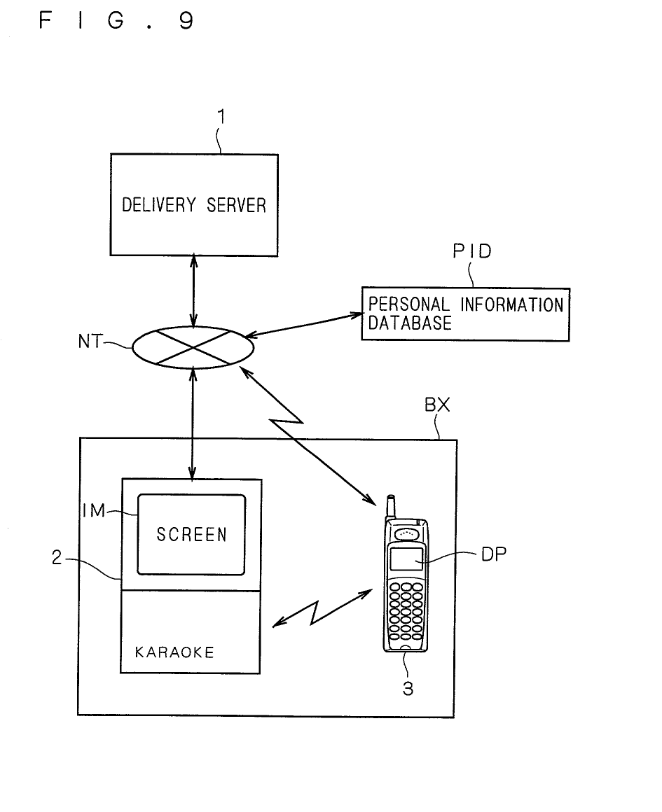

As shown in FIG. 9, for example, it is possible to implement such a structure that a karaoke user can store the questionnaire QN of FIG. 7 in a self-personal information terminal 3 and can send information about the questionnaire QN to a receiving terminal 2 in a karaoke box BX, thereby transmitting the information about the questionnaire QN to the delivery server 1 through the receiving terminal 2 and a network NT. Alternatively, access may be directly given from the personal information terminal 3 to the delivery server 1 through the network NT to transmit the information about the questionnaire QN to the delivery server 1.

Moreover, storage means (not shown) may be provided on the receiving terminal 2 to store the information about the questionnaire QN therein and to transmit the same information to the delivery server 1.

In addition, a personal information database (for example, a telephone book database in a telephone station or the like) PID capable of accessing the delivery server 1 through the network NT may store the information about the questionnaire QN and may transmit the same information to the delivery server 1 under control of the personal information terminal 3 of the user.

With such a structure that the delivery server 1, the receiving terminal 2, other external storage means 3 or PID stores the user information therein and the delivery server 1 refers to the same information, thus, it is not necessary for the user to answer the questionnaire every time the user information is given to the delivery server 1. Thus, the user is not burdened with information input.

With such a structure that the user information is given to the delivery server 1 by the operation of the personal information terminal owned by the user, moreover, each user can also use his (her) own personal information terminal as a remote control for operating the receiving terminal 2.

In FIG. 5, the reference numeral 3 denotes a structure of the personal information terminal. The personal information terminal 3 has accessor attribute data storage means AAD for storing user information, an input/output interface IF3 for externally exchanging information, input means IN such as a keyboard for inputting the user information, a display section DP for displaying the input information and control means CT3 such as a CPU for controlling each of the portions.

Moreover, in the case in which the receiving terminal 2 is to exchange information with the personal information terminal 3, an input/output interface IF2b (for example, an interface based on the bluetooth technique) is preferably provided on the receiving terminal 2 as shown in FIG. 5.

In order to prevent the leakage of a privacy in the. exchange of the user information, the user information is preferably enciphered and given to the delivery server 1. More specifically, the user information is preferably enciphered and transmitted by the SSL (Secure Socket Layer) technique, for example. Thus, the user information can be protected.

### Fifth Embodiment

The present embodiment is a variant of the music delivery system according to the fourth embodiment. In such a music delivery system, a user can indicate the contents of change of a change data block to change musical accompaniment data or lyrics data.

For example, the portion “B.” in FIGS. 1 and 2 may be constituted to be changed into another keyword such as B-1 or B-2 shown in the related information TB2 of FIG. 6. In the B-1, items of “Nagoya Dome”, “Fukuoka Dome” and “Sapporo Dome” are names of a famous baseball field in “Nagoya”, “Hakata” and “Sapporo”, respectively. In the B-2, items of “Mizuho Ground”, “Hakata-no-Mori Ground” and “Sapporo Atsubetsu Park Sports Stadium” are names of a famous soccer stadium in the “Nagoya”, the “Hakata” and the “Sapporo”, respectively.

In this case, the delivery server 1 prepares a selection choice such as B-1 or B-2 so that the user can select the selection choice from a self-personal information terminal 3, for example.

Moreover, the user may store the contents to be changed in the self-personal information terminal 3 and may transmit the contents of change to the delivery server 1, thereby changing musical accompaniment data or lyrics data to be delivered.

In that case, preferably, the personal information terminal 3 is provided with parody data storage means VSD such that the user can previously store musical accompaniment data and/or lyrics data to be changed and can transmit the same data to the delivery server 1 as shown in FIG. 5.

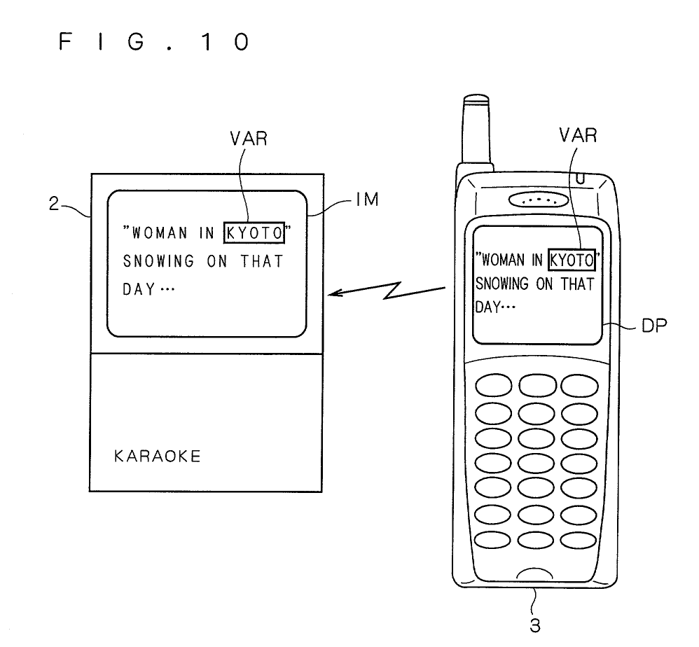

For example, in the case in which the lyrics of “Woman in ◯◯” in FIG. 1 or 2 are to be changed into “Woman in Kyoto” as shown in a changed portion VAR of FIG. 10, the parody data storage means VSD is caused to store data on a change of “B.” in the lyrics data into “Kyoto” and to transmit the same data to the delivery server 1 through a receiving terminal 2.

If the user can thus change a change data block into favorite contents, it is possible to implement a music delivery system capable of providing a music with which each listener can gain sympathy more easily.

In the case in which a user is to sing, in a karaoke box, a tune which is not stored in the delivery server 1, the user may previously acquire lyrics data and musical accompaniment data on the tune by himself (herself) (for example, the musical accompaniment data are downloaded from his (her) own CD to the personal information terminal 3), thereby uploading the same data to the receiving terminal 2.

### Sixth Embodiment

The present embodiment is a variant of the music delivery system according to the fifth embodiment, in which a change data block of lyrics data is changed while referring to an indication of the contents of change of the change data block carried out in the past by another user having an attribute or taste coincident with that of an accessing user.

In general, it is apparent that another person having the same taste often carries out same selection to be desired. Accordingly, if the same change is carried out for a current accessing user with-reference to the contents of change of the change data block which was performed in the past by another user having an attribute or taste coincident with that of the accessing user, it is possible to implement a music delivery system capable of providing a music with which the accessing user can easily gain sympathy because the attribute or taste is supposed to be similar or close.

For example, assuming that another user gives “baseball” as “favorite sports” in the questionnaire of FIG. 7 and selects, as a selection choice, B-1 shown in the related information TB2 of FIG. 6, it is supposed that the contents of change of the change data block may be B-1 if a current accessing user gives the “baseball” as the “favorite sports”.

Such a processing can easily be implemented by causing control means CT1 of a delivery server 1 to change a change data block while referring to user information about an accessing user and user information about another user which is stored in accessor attribute storage means ATO. It is preferable that the user information of each user should be stored as a database in the accessor attribute storage means ATO.

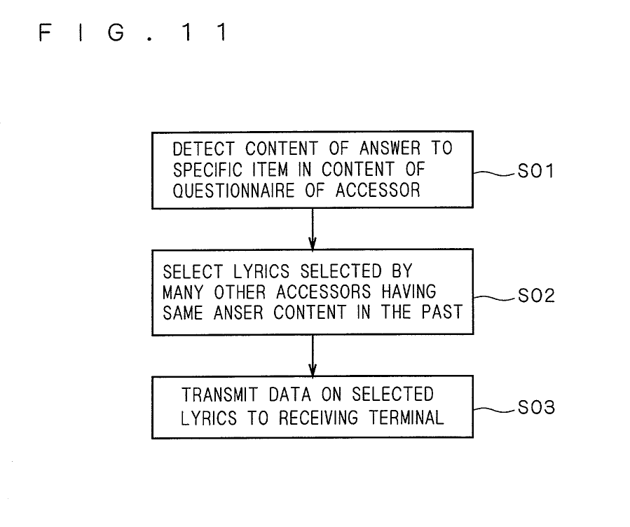

FIG. 11 shows an example of the flow. In FIG. 11, first of all, the control means CT1 detects the contents of an answer for a specific item related to a taste, for example, in the contents of a questionnaire for an accessor as shown in Step S01. As shown in Step S02, next, the control means CT1 retrieves and selects lyrics selected by a large number of other accessors having the same answer contents in the past while referring to information in the accessor attribute storage means ATO. As shown in Step S03, then, the control means CT1 delivers data on the selected lyrics to the receiving terminal 2.

### Seventh Embodiment

The present embodiment is a variant of the music delivery system according to the third to sixth embodiments, in which the contents of a background video to be displayed at a receiving terminal 2 are changed based on the change of a change data block in addition to the change of a tune.

At the receiving terminal 2 provided in a karaoke box, a background video is generally displayed together with lyrics telop. In the present embodiment, the background video to be displayed is also changed based on the change of the change data block.

For example, as shown in FIG. 5, a back video database BVD storing a large number of background videos is provided in the receiving terminal 2. If a keyword in the related information TB2 of FIG. 6 is related to each background video, a proper background video corresponding to lyrics or a musical accompaniment can be displayed.

In the related information TB2 of FIG. 6, for example, in the case in which “Aichi Ken” is included as an attribute of an accessor, it is preferable that a video of the “Aichi Ken” should be displayed as the background video. Consequently, it is possible to implement a music delivery system capable of providing, together with a video, a music with which each listener can easily gain sympathy.

### Eighth Embodiment

The present embodiment is a variant of a music delivery system according to the first to seventh embodiments, in which the number of tune deliveries is totalized as the total number of deliveries, and furthermore, the number of tune deliveries is totalized as the number of deliveries according to a type for each type of change of a change data block and the total number of deliveries and the number of deliveries according to the type are delivered to a receiving terminal or the total number of deliveries is delivered, to the receiving terminal, as a result of totalization for one of the types of the change.

A user to desire the delivery of a music including karaoke is generally interested in which tune is popular and tends to listen to or sing the popular tune. Accordingly, the user is often informed of the number of deliveries of the tune.

In the present embodiment, the user is informed of the number of deliveries of a tune for each type of change of a change data block as the number of deliveries according to a type so that the user is caused to recognize which change type is popular. Alternatively, the user is informed of the total number of deliveries as a result of totalization for one of the types of the change so that the user is caused to recognize that a specific change type is popular.

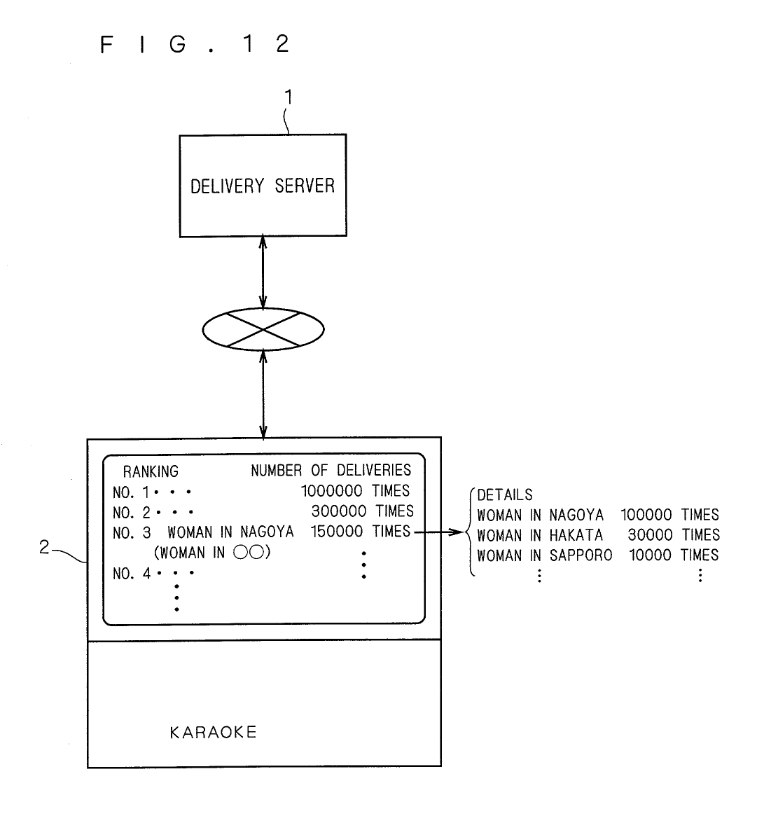

For example, as shown in FIG. 12, a delivery server 1 delivers, to a receiving terminal 2, a result of totalization of the total number of deliveries for a tune of lyrics LY1. At this time, the details can be expressed for each type of the change of a change data block as a method of giving a notice of the result of totalization (that is, “Woman in Nagoya” of 100000 times, “Woman in Hakata” of 30000 times and “Woman in Sapporo” of 10000 times can be expressed). That is, the user can be informed of the number of tune deliveries as the number of deliveries according to a type. On the other hand, the user can also be informed of the total number of deliveries of 150000 times for the tune having the lyrics LY1 as a result of totalization for one type of “Woman in Nagoya” at the receiving terminal 2 of “Nagoya”.

In the former case, the user can be caused to recognize which change type is popular, thereby increasing the number of deliveries of the whole tune or increasing the number of deliveries of a tune subjected to some type of change (for example, the number of deliveries of the “Woman in Nagoya” having a large number of deliveries can be more increased). In the latter case, moreover, it is possible to increase the number of tune deliveries by causing the user to have such a recognition that a specific change type is popular (that is, the number of deliveries of the “Woman in Nagoya” can be seen to be larger than the number of actual deliveries). For example, consequently, the number of deliveries of the whole tune can be increased.

In order to carry out such totalization, it is preferable that the delivery server 1 should be provided with chart totalization result storage means HCD for storing each totalization result and delivering the result to the receiving terminal 2 as shown in FIG. 5.

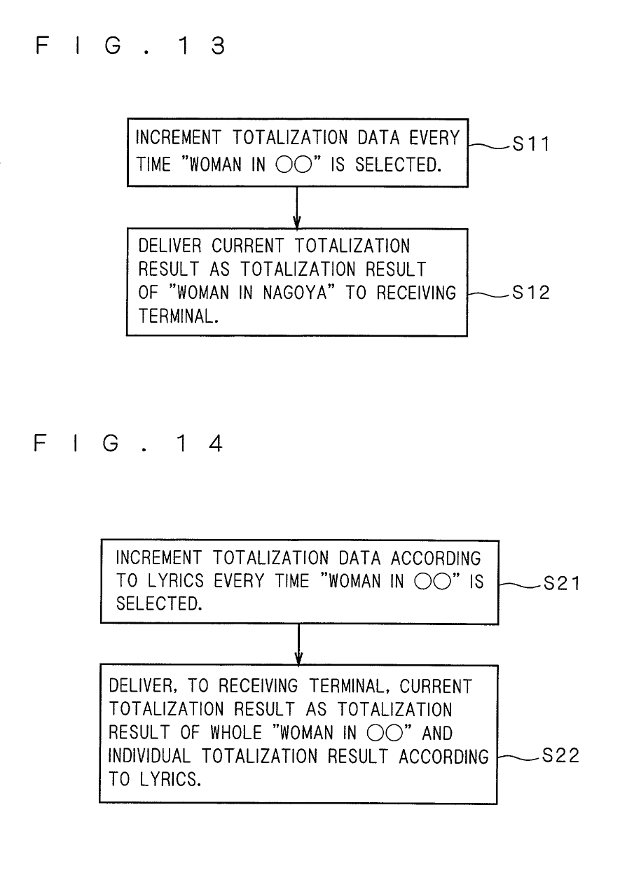

As a totalizing method, in the case in which the manager of the server wants to let the user recognize that a specific change type is popular, totalization data to be stored in the chart totalization result storage means HCD are incremented every time “Woman in ◯◯” is selected as shown in Step S11 of FIG. 13 and a current totalization result is delivered to be a totalization result of a specific change type (for example, one type of totalization result of the “Woman in Nagoya”) as shown in Step S12.

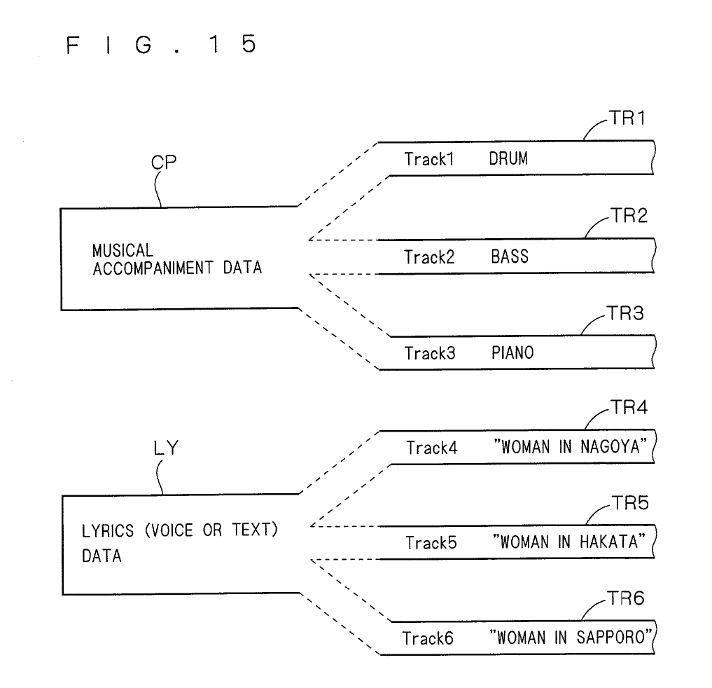

On the other hand, in the case in which the details are expressed to cause the user to recognize which change type is popular, totalization data to be stored in the chart totalization result storage means HCD are incremented every time “Woman in ◯◯” is selected as shown in Step S21 of FIG. 14 and a current totalization result is delivered to be a totalization result of the total number of deliveries and an individual totalization result as shown in Step S22.

### Ninth Embodiment

The present embodiment is a variant of the music delivery system according to the first to seventh embodiments, in which musical accompaniment data and lyrics data are constituted by a plurality of tracks, each of the tracks is regarded as a change data block and a delivery server 1 serves to carry out a delivery on a unit of one track.

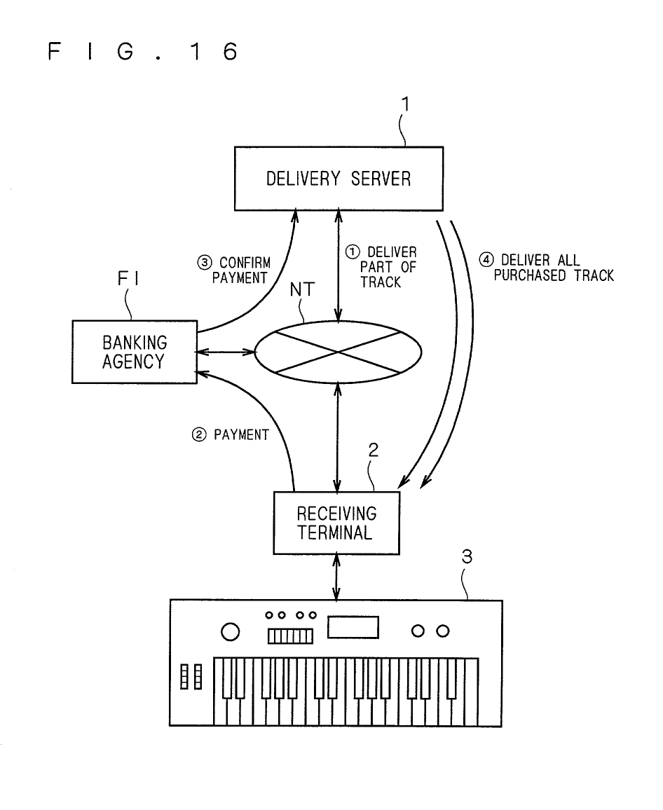

For example, in the case in which the musical accompaniment data are MIDI data, musical accompaniment data CP can be constituted as tracks TR1 to TR3 according to a tone of an instrument (for example, TR1 is a track of a drum, TR2 is a track of a bass and TR3 is a track of a piano) as shown in FIG. 15. Moreover, the lyrics data LY can also be stored as tracks TR4 to TR6 according to the type of the change data block (for example, each of “Woman in Nagoya”, “Woman in Hakata” and “Woman in Sapporo”).

In this case, for example, it is possible to carry out a delivery for each track to a user. For example, the tracks TR1 to TR4 can be delivered to a user to desire the “Woman in Nagoya”, and the tracks TR1 to TR3 and TR5 can be delivered to a user to desire the “Woman in Hakata”. In addition, for example, only the track TR3 can also be delivered to a user to require only the track of the piano.

Thus, the user can desire the delivery of only a necessary track.

Moreover, it is preferable that accounting for a delivery should be carried out according to the number of the tracks to be delivered. Consequently, it is also possible to experimentally deliver only one track and to pay a value to require the delivery of all the tracks only when the user likes it, for example.

FIG. 16 is a diagram illustrating the foregoing, in which the delivery server 1 delivers a part of the tracks to a receiving terminal 2 free, for example. In the case in which a user receiving the tracks likes the tune and desires the delivery of all the tracks, he (she) pays money to a banking agency Fl previously specified by a manager of the delivery server 1 through a method such as electronic settlement. After the delivery server 1 confirms the payment, the user delivers all the purchased tracks.

Thus, the user can connect a personal information terminal 3 (for example, a synthesizer is illustrated) to the receiving terminal 2, for example, thereby downloading data on each track.

In this case, for example, the user can receive only the track TR1 of the drum free and can make residual tracks by himself (herself) or the user can purchase all the tracks to enjoy the reproduction of a tune through the personal information terminal 3. Thus, a flexible delivery can be carried out.

While the invention has been shown and described in detail, the foregoing description is in all aspects illustrative and not restrictive. It is therefore understood that numerous modifications and variations can be devised without departing from the scope of the invention.

What is claimed is:

1. A music delivery system comprising, a delivery server for storing at least one of musical accompaniment data and lyrics data of a plurality of tunes including at least one of a musical accompaniment and lyrics and for delivering said data on request; and
a receiving terminal for giving a request for delivering at least one of said musical accompaniment data and said lyrics data to said delivery server and receiving said delivery upon receipt of an instruction from a user, wherein,
a part of or all of at least one of said musical accompaniment data and said lyrics data are constituted by a change data block which can be changed and
at least one of said musical accompaniment data and said lyrics data can be thereby changed at said delivery server or said receiving terminal.

2. The music delivery system according to claim 1, wherein
said lyrics data include data on voice singing lyrics.

3. The music delivery system according to claim 1, wherein
said lyrics data include data on text notating lyrics in characters.

4. The music delivery system according to claim 1, wherein
said lyrics of said lyrics data include a portion of a name of a place and said portion is said change data block,
positional information about a position of presence of said receiving terminal is given to said delivery server, and
said delivery server changes said change data block in said lyrics data based on said positional information.

5. The music delivery system according to claim 1, wherein
said lyrics of said lyrics data include a portion related to an attribute or taste of said user and said portion related to said attribute or taste is said change data block,
user information related to said attribute or taste of said user is given to said delivery server, and
said delivery server changes said change data block in said lyrics data based on said user information.

6. The music delivery system according to claim 5, wherein
said user information includes an access record that said user accessed said receiving terminal in the past.

7. The music delivery system according to claim 5, wherein
said change data block includes a plurality of selection choices,
said user information is given to said delivery server in a format of a questionnaire in which said user selects a corresponding keyword, and
said keyword and said selection choice of said change data block are related to each other and said selection choice of said change data block is selected based on said selected keyword.

8. The music delivery system according to claim 5, wherein
said user information is stored in said delivery server, said receiving terminal or other external storage means and said delivery server refers to said user information.

9. The music delivery system according to claim 8, wherein
said user information is given by operation of a personal information terminal owned by said user.

10. The music delivery system according to claim 5, wherein
said user information is enciphered and given to said delivery server.

11. The music delivery system according to claim 1, wherein
at least one of said musical accompaniment data and said lyrics data can be changed by indication of contents of change of said change data block from said user.

12. The music delivery system according to claim 11, wherein
said lyrics of said lyrics data include a portion related to an attribute or taste of said user and said portion related to said attribute or taste is said change data block,
user information related to said attribute or taste of said user is given to said delivery server, and
said delivery server changes said change data block in said lyrics data based on said user information and reference is made to an indication of said contents of change of said change data block carried out in the past by another user having at least a part of said user information coincident with that of an accessing user during said change.

13. The music delivery system according to claim 1, wherein
said receiving terminal can display a video, and
contents of said video are changed based on said change of said change data block.

14. The music delivery system according to claim 1, wherein
said change has a plurality of types,
said delivery server totalizes the number of said deliveries of said tune as the total number of deliveries without depending on presence and type of said change, and furthermore, said number of said deliveries of said tune is totalized as the number of deliveries according to a type for each type of said change, and
said total number of deliveries and said number of deliveries according to a type are delivered to said receiving terminal.

15. The music delivery system according to claim 1, wherein
said change has a plurality of types, and
said delivery server totalizes the number of said deliveries of said tune as the total number of deliveries without depending on presence and type of said change, and furthermore, said total number of deliveries is delivered, to said receiving terminal, as a result of totalization for one of said types of said change.

16. The music delivery system according to claim 1, wherein at least one of said musical accompaniment data and said lyrics data are constituted by a plurality of tracks,
each of said tracks corresponds to said change data block, and
said delivery server carries out a delivery on a unit of said track.

17. The music delivery system according to claim 16, wherein accounting for said delivery is carried out depending on the number of said tracks to be delivered.
